(19) United States
(12) Patent Application Publication
(10) Pub. No.: US 2021/0068585 A1
(43) Pub. Date: Mar. 11, 2021

(54) ELECTROMECHANICAL ACTUATOR FOR ROTATING GRILLS

(71) Applicant: Vector Indústria de Produtos Metalúrgicos Ltda, Caxias do Sul (BR)

(72) Inventor: Eliane Luisa Stocker, Caxias do Sul (BR)

(73) Assignee: Vector Indústria de Produtos Metalúrgicos Ltda, Caxias do Sul (BR)

(21) Appl. No.: 16/686,772

(22) Filed: Nov. 18, 2019

(30) Foreign Application Priority Data
Sep. 11, 2019 (BR) 10 2019 018878

(51) Int. Cl. A47J 37/04; A47J 37/07

(52) U.S. Cl. CPC A47J 37/04; A47J 37/0786

(57) ABSTRACT

Electromechanical Actuator for Rotating Grills refers to an electromechanical actuator used in rotating grills, barbecue grills, roasters or ovens for domestic or commercial purposes, enabling the use of this equipment in places or situations where there is no electricity available. The electromechanical actuator provides actuation by the use of batteries of any voltage, directly coupled to the grill's rotation system, composed of a small motor connected to a compartment where the batteries are placed, containing an actuation button. A single electromechanical actuator can be used for the rotating motion of rotating grills, barbecue grills or roasters.

### SUBJECT

The present Invention Patent refers to an electromechanical actuator used in grills, barbecue grills, or rotating ovens, for domestic or commercial use, enabling the utilization of this equipment in places or situations where there is no electric power available. The electromechanical actuator provides actuation by the use of batteries of any voltage, directly coupled to the rotation system of the grills, composed of a small motor connected to a compartment where the batteries are placed, containing an actuation button. A single electromechanical actuator can be used for rotating motion of rotating grills, roasters or barbecue grills.

### STATE OF THE ART

In general, food roasters or barbecues grills, whether gas-fired, electric or charcoal-fired, with a mechanism for rotating skewers or grates have the activation of this mechanism entirely dependent on an electric power grid.

It so happens that portable grills are not always used in places where the power grid is available, such as terraces, camping sites, gardens, beaches, parks, etc. In these situations the rotation mechanism of the skewers or grates cannot be used, limiting the potential of the equipment, and generating discomfort to the user.

Therefore, it is unknown by the technique other actuation devices for rotating grills that are portable and allow to dispense the utilization of an electric power grid, being also appropriate for several types of existing equipments, that use a number of different devices.

### INVENTIVE CONCEPT

The present Electromechanical Actuator for Rotating Grills was developed to enable the use of rotating grills in situations in which the electric power grid is not available or its use is unfeasible, being the actuator portable, easily and practically attachable and suitable for use in various models of equipment.

Therefore, this object aims to solve the technical problem related to the actuation alternative to the electric power grid of mechanisms of skewers rotation in grills, barbecue grills, roasters or ovens.

For this purpose, a small motor with a shaft is coupled to the rotation mechanism of the equipment already in use, being this motor driven by batteries, rechargeable or not. An on/off button is used to actuate the assembly.

### APPLICATION FIELD

The application of the Electromechanical Actuator for Rotating Grills occurs as an actuation device to the rotation mechanism using batteries.

### Advantages

The Electromechanical Actuator for Rotating Grills presents as advantages:
Enables the use of grills, barbecue grills, roasters, ovens or similars equipped with a mechanism for rotating skewers or grates in situations in which the electric power network is not available;
Enables the use of batteries of any voltage, rechargeable or not;
May be coupled to several models of grills, barbecue grills, roasters or ovens existing today in the market or already in use, in an easy and practical way, independently of the rotation mechanism used, if with belts, chains, gears, worm gears, etc.;
Due to its portable feature, it is easily used in many different situations;
By using a single actuator, a set of 2 to 15 skewers can be moved at the same time, turning it into an economical alternative;
As many actuators as necessary can be used, depending on the type of equipment;
It can be used to move a set of grates instead of skewers.

### ILLUSTRATIONS

In order to facilitate research and provide understanding of this patent, as recommended in the report, according to a basic and preferential form of realization prepared by the applicant, reference is made to the illustrations attached, which integrate and subsidize this descriptive report where the:

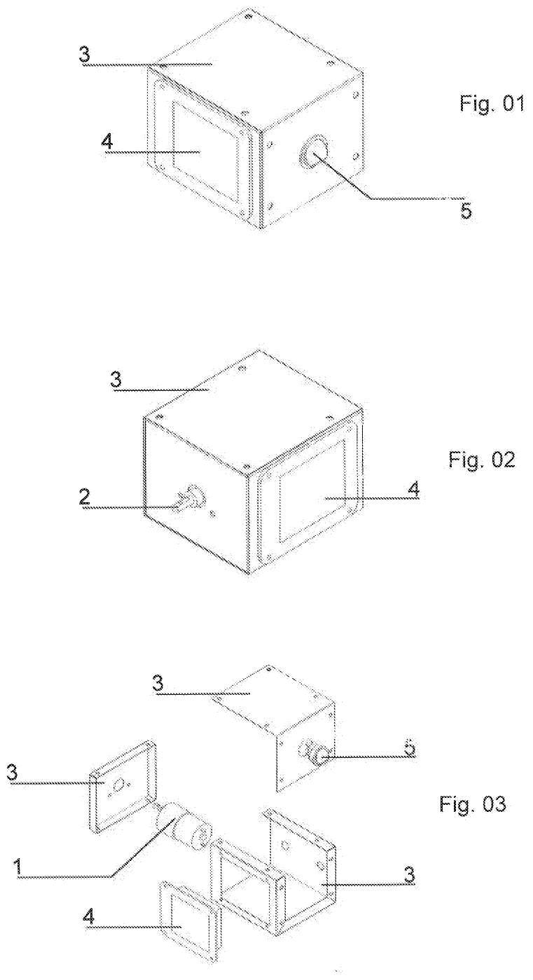

FIG. 1—displays the front view of the actuator;

FIG. 2—displays the rear view of the actuator;

FIG. 3—displays the exploded view of the actuator;

### DESCRIPTION

The Electromechanical Actuator for Rotating Grills consists of the electric motor (1) with a shaft end (2) that fits in the centre of the fairing (3). The shaft end (2) provides rotation transmission for various types of gearing of grills or roasters.

The compartment (4) is used to fit the batteries and the actuation button (5) is connected to it.

For operation, simply couple the shaft end (2) of the motor (1) to the existing gear, independent of the rotation mechanism used, if with belts, chains, gears, worm gears, etc. For rotation in grills, barbecue grills, roasters or ovens, a single actuator can be used to rotate up to 15 skewers or grids simultaneously, independently of other constructive aspects of the rotation mechanisms, being used in several types and models of grills, barbecue grills, roasters or ovens.

The choice between batteries or cells to be attached to the compartment (4) depends only on the availability of the user, being them rechargeable or not.

### CONCLUSION

Thus, the Electromechanical Actuator for Rotating Grills is subsidized by unprecedented technical and functional characteristics, therefore deserving the legal protection claimed.

1. The ELECTROMECHANICAL ACTUATOR FOR ROTATING GRILLS is characterized by the fact that the electromechanical actuator uses batteries to power the electric motor (1) and is attached to the gearing of the rotating grills.

2. The ELECTROMECHANICAL ACTUATOR FOR ROTATING GRILLS according to claim 1, characterized by the electric motor (1) is endowed with a shaft end (2) that fits inside the fairing (3), which contains a compartment (4) to fit the batteries and the actuation button (5).
